(19) United States
(12) Patent Application Publication
(10) Pub. No.: US 2024/0399633 A1
(43) Pub. Date: Dec. 5, 2024

(54) DISPLAY DEVICE OF INJECTION MOLDING MACHINE, AND INJECTION MOLDING MACHINE

(71) Applicant: SUMITOMO HEAVY INDUSTRIES, LTD., Tokyo (JP)

(72) Inventors: Takuya MATSUNAGA, Chiba (JP); Hajime ONO, Chiba (JP)

(21) Appl. No.: 18/652,261

(22) Filed: May 1, 2024

(30) Foreign Application Priority Data
Jun. 2, 2023 (JP) 2023-091547

(51) Int. Cl. B29C 45/17; B29C 45/76

(52) U.S. Cl. CPC B29C 45/1774; B29C 45/76; B29C 2045/7606; B29C 2945/76498; B29C 2945/76595; B29C 2945/76658

(57) ABSTRACT

A display device of an injection molding machine includes a circuit configured to display a guidance screen that assists in providing conditions of an injection process. The injection process sequentially includes a filling process of controlling a travel speed of an injection member, a stopping process of stopping travel of the injection member, and a dwelling process of controlling a pressure applied from the injection member to a molding material. The guidance screen includes a first input field configured to receive an input of conditions upon completion of the filling process in a first test molding. In the first test molding, the filling process is performed under the conditions input to the first input field and subsequently the stopping process is performed, and then the dwelling process is performed under conditions that enable confirming a forward flow end position of the molding material upon completion of the stopping process.

### CROSS-REFERENCE TO RELATED APPLICATIONS

This application is based upon and claims priority to Japanese Patent Application No. 2023-091547, filed on Jun. 2, 2023, the entire contents of which are incorporated herein by reference.

### BACKGROUND

### 1. Technical Field

The present disclosure relates to display devices of injection molding machines, and injection molding machines.

### 2. Description of Related Art

Injection molding machines include an injection member configured to inject a molding material from a cylinder into a mold part, and a drive source configured to move the injection member. The injection member is provided inside the cylinder. The injection member is, for example, a screw. The molding material is, for example, resin. The molding material is melted inside the cylinder and injected from the cylinder into the mold part.

According to the existing injection molding machine-controlling method, once the pressure obtained by a cavity pressure sensor disposed in the mold reaches a preset pressure after the injection process starts, a screw is stopped at a screw position at that time. The screw is stopped for a preset period of time. Subsequently, a dwelling process is performed.

The injection process sequentially includes a filling process of controlling a speed at which the injection member moves forward, a stopping process of stopping the movement of the injection member, and a dwelling process of controlling the pressure applied from the injection member to the molding material. In the stopping process, the molding material flows into the mold part by the action of the residual pressure. By utilizing the residual pressure, an excessive increase in the pressure can be suppressed, and molding failures, such as burrs and the like, can be suppressed. In addition, the mold clamping force can be reduced.

Test molding is performed to provide conditions of the injection process. Test molding is performed repeatedly while changing the conditions of the injection process. The conditions upon completion of the filling process are provided so that the molding material flows into the mold part by the action of the residual pressure in the stopping process. The conditions upon completion of the filling process include, for example, the position of the injection member (so-called V/P switchover position), the travel speed of the injection member, and the upper limit of the pressure applied from the injection member to the molding material.

Hitherto, under the provided conditions upon completion of the filling process, whether or not the molding material flows into the mold part by the action of the residual pressure in the stopping process is sometimes unknown because the conditions of the dwelling process are inappropriate. Therefore, it is challenging for lower skilled users to provide the conditions of the injection process that produce the effect of the stopping process.

### SUMMARY

A display device of an injection molding machine according to one aspect of the present disclosure includes a circuit configured to display a guidance screen that assists in providing conditions of an injection process. The injection process sequentially includes a filling process of controlling a travel speed of an injection member, a stopping process of stopping travel of the injection member, and a dwelling process of controlling a pressure applied from the injection member to a molding material. The guidance screen includes a first input field configured to receive an input of conditions upon completion of the filling process in a first test molding. In the first test molding, the filling process is performed under the conditions input to the first input field and subsequently the stopping process is performed, and then the dwelling process is performed under conditions that enable confirming a position of the molding material upon completion of the stopping process, the position being a position of a forward end of the molding material in a direction in which the molding material flows (hereinafter this position may be referred to as “forward flow end position”).

### BRIEF DESCRIPTION OF THE DRAWINGS

FIG. 1 is a diagram illustrating the state of an injection molding machine according to an embodiment upon completion of mold opening;

FIG. 2 is a diagram illustrating the state of the injection molding machine according to the embodiment during mold clamping;

FIG. 3 is a diagram illustrating a functional block of an example of components of a controller;

FIG. 4 is an example of a molding cycle process;

FIG. 5 is a diagram illustrating an example of a setting screen of an injection process;

FIG. 6 is a flowchart illustrating an example of providing conditions of the injection process using a guidance screen;

FIG. 7 is a diagram illustrating an example of a guidance screen immediately before step S101;

FIG. 8 is a diagram illustrating an example of a guidance screen immediately after step S201;

FIG. 9 is a diagram illustrating an example of a guidance screen immediately after step S203;

FIG. 10 is a diagram illustrating an example of a guidance screen immediately after step S205; and

FIG. 11 is a diagram illustrating an example of a guidance screen immediately after step S206.

### DETAILED DESCRIPTION

One aspect of the present disclosure provides a technique of appropriately setting conditions of the injection process.

Embodiments of the present disclosure will be described with reference to the drawings. In the drawings, the same or corresponding configurations are referred to using the same or corresponding symbols, and description thereof may be omitted.

### (Injection Molding Machine)

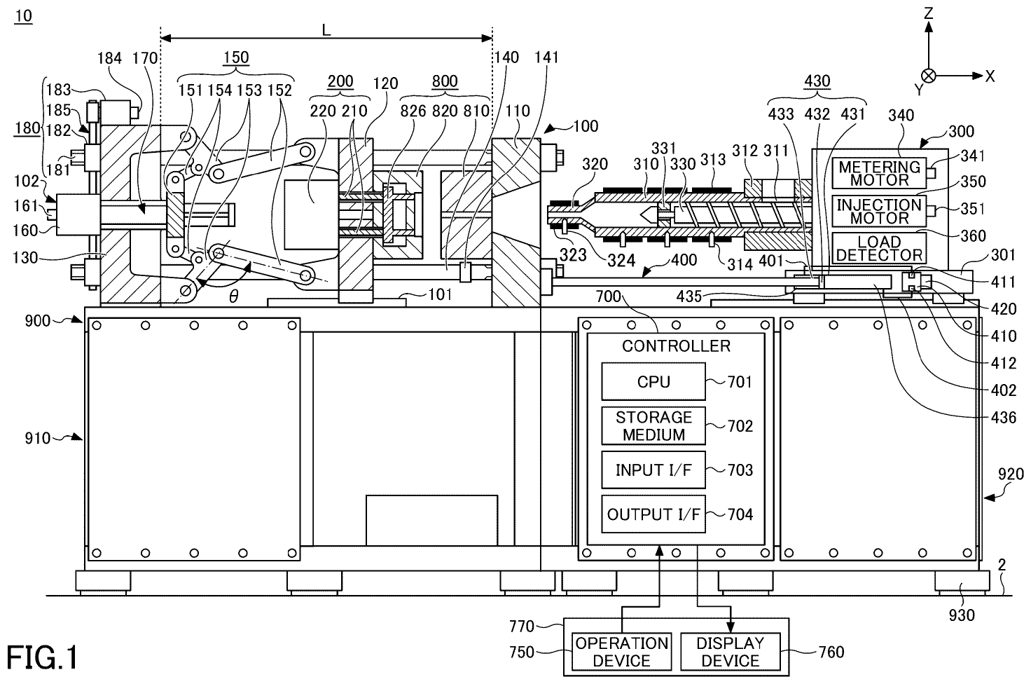

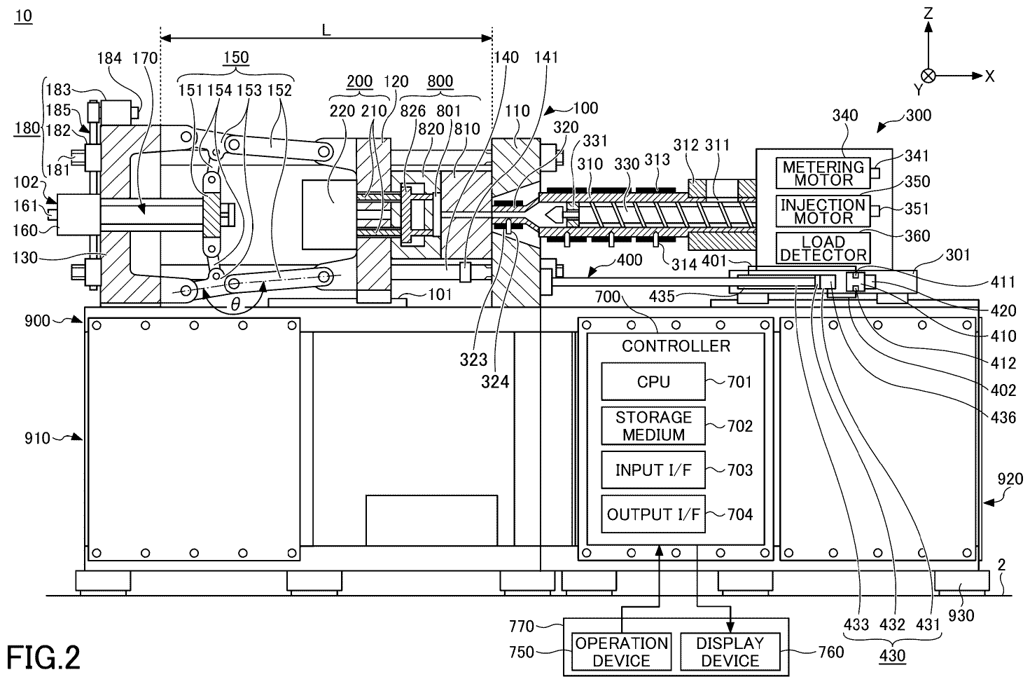

FIG. 1 is a diagram illustrating the state of an injection molding machine according to an embodiment upon completion of mold opening. FIG. 2 is a diagram illustrating the state of the injection molding machine according to this embodiment during mold clamping. In this specification, the X-axis direction, the Y-axis direction, and the Z-axis direction are perpendicular to each other. The X-axis direction and the Y-axis direction represent horizontal directions, and the Z-axis direction represents a vertical direction. When a mold clamping part 100 is of a horizontal type, the X-axis direction is a mold opening/closing direction, and the Y-axis direction is a widthwise direction of an injection molding machine 10. The negative side in the Y-axis direction is referred to as “operation side”, and the positive side in the Y-axis direction is referred to as “non-operation side.”

As illustrated in FIG. 1 and FIG. 2, the injection molding machine 10 includes the mold clamping part 100 that opens and closes a mold part 800, an ejector 200 that ejects a molded product in the mold part 800, an injection part 300 that injects a molding material into the mold part 800, a movement part 400 that moves the injection part 300 toward and away from the mold part 800, a controller 700 that controls the components of the injection molding machine 10, and a frame 900 that supports the components of the injection molding machine 10. The frame 900 includes a mold clamping part frame 910 that supports the mold clamping part 100 and an injection part frame 920 that supports the injection part 300. Each of the mold clamping part frame 910 and the injection part frame 920 is installed on a floor 2 via at least one leveling adjuster 930. The controller 700 is placed in the internal space of the injection part frame 920. Each component of the injection molding machine 10 is described below.

### (Mold Clamping Part)

In the description of the mold clamping part 100, the direction of movement of a movable platen 120 during mold closing (e.g., the positive X-axis direction) is referred to as “forward direction”, and the direction of movement of the movable platen 120 during mold opening (e.g., the negative X-axis direction) is referred to as “backward direction.”

The mold clamping part 100 closes, pressurizes, clamps, depressurizes, and opens the mold part 800. The mold part 800 includes a stationary mold 810 and a movable mold 820.

The mold clamping part 100 is, for example, of a horizontal type, and the mold opening and closing directions are horizontal directions. The mold clamping part 100 includes a stationary platen 110 to which the stationary mold 810 is attached, the movable platen 120 to which the movable mold 820 is attached, and a movement mechanism 102 that moves the movable platen 120 in the mold opening and closing directions relative to the stationary platen 110.

The stationary platen 110 is fixed to the mold clamping part frame 910. The stationary mold 810 is attached to a surface of the stationary platen 110 that faces the movable platen 120.

The movable platen 120 is placed to be movable in the mold opening and closing directions relative to the mold clamping part frame 910. A guide 101 that guides the movable platen 120 is laid on the mold clamping part frame 910. The movable mold 820 is attached to a surface of the movable platen 120 that faces the stationary platen 110.

The movement mechanism 102 moves the movable platen 120 toward and away from the stationary platen 110 to close, pressurize, clamp, depressurize, and open the mold part 800. The movement mechanism 102 includes a toggle support 130 spaced apart from the stationary platen 110, a tie bar 140 connecting the stationary platen 110 and the toggle support 130, a toggle mechanism 150 that moves the movable platen 120 in the mold opening and closing directions relative to the toggle support 130, a mold clamping motor 160 that actuates the toggle mechanism 150, a motion conversion mechanism 170 that converts the rotational motion of the mold clamping motor 160 into linear motion, and a mold thickness adjustment mechanism 180 that adjusts the interval between the stationary platen 110 and the toggle support 130.

The toggle support 130 is spaced apart from the stationary platen 110 and is placed on the mold clamping part frame 910 to be movable in the mold opening and closing directions. The toggle support 130 may be placed to be movable along a guide laid on the mold clamping part frame 910. The guide 101 of the movable platen 120 may also serve as the guide of the toggle support 130.

According to this embodiment, the stationary platen 110 is fixed to the mold clamping part frame 910 and the toggle support 130 is placed to be movable in the mold opening and closing directions relative to the mold clamping part frame 910. However, the toggle support 130 may be fixed to the mold clamping part frame 910 and the stationary platen 110 may be placed to be movable in the mold opening and closing directions relative to the mold clamping part frame 910.

The tie bar 140 connects the stationary platen 110 and the toggle support 130 with an interval (distance) L therebetween in the mold opening and closing directions. Multiple (e.g., four) tie bars may be used as the tie bar 140. The multiple tie bars 140 are placed parallel to the mold opening and closing directions and extend according to a mold clamping force. At least one tie bar 140 among the multiple tie bars 140 may be provided with a tie bar strain detector 141 that detects the strain of the tie bar 140. The tie bar strain detector 141 transmits a signal indicating the detection result to the controller 700. The detection result of the tie bar strain detector 141 is used to detect the mold clamping force.

According to this embodiment, the tie bar strain detector 141 is used as a mold clamping force detector to detect a mold clamping force. The present disclosure, however, is not limited to this configuration. The mold clamping force detector is not limited to be of a strain gauge type and may be of a piezoelectric type, a capacitive type, a hydraulic type, an electromagnetic type, or the like, and its attachment position is not limited to the tie bar 140.

The toggle mechanism 150 is placed between the movable platen 120 and the toggle support 130, and moves the movable platen 120 in the mold opening and closing directions relative to the toggle support 130. The toggle mechanism 150 includes a crosshead 151 that moves in the mold opening and closing directions and a pair of link groups that are extended and contracted by the movement of the crosshead 151. Each link group includes a first link 152 and a second link 153 that are extendable and contractible when connected by a pin or the like. The first link 152 is pivotably attached to the movable platen 120 with a pin or the like. The second link 153 is pivotably attached to the toggle support 130 with a pin or the like. The second link 153 is attached to the crosshead 151 via a third link 154. The crosshead 151 is moved toward or away from the toggle support 130 to contract or extend the first link 152 and the second link 153 to move the movable platen 120 toward or away from the toggle support 130.

The configuration of the toggle mechanism 150 is not limited to the configuration illustrated in FIG. 1 and FIG. 2. For example, the number of nodes of each link group, which is five in FIG. 1 and FIG. 2, may be four, and one end of the third link 154 may be connected to the node of the first link 152 and the second link 153.

The mold clamping motor 160 is attached to the toggle support 130 to actuate the toggle mechanism 150. The mold clamping motor 160 moves the crosshead 151 toward or away from the toggle support 130 to contract or extend the first link 152 and the second link 153 to move the movable platen 120 toward or away from the toggle support 130. The mold clamping motor 160, which is directly connected to the motion conversion mechanism 170, may alternatively be connected to the motion conversion mechanism 170 via a belt or pulley.

The motion conversion mechanism 170 converts the rotational motion of the mold clamping motor 160 into the linear motion of the crosshead 151. The motion conversion mechanism 170 includes a screw shaft and a screw nut screwed to the screw shaft. Balls or rollers may be interposed between the screw shaft and the screw nut.

The mold clamping part 100 performs a mold closing process, a pressurizing process, a mold clamping process, a depressurizing process, a mold opening process, and the like under the control of the controller 700.

In the mold closing process, the mold clamping motor 160 is driven to move the crosshead 151 forward to a mold closing completion position at a set travel speed to move the movable platen 120 forward to cause the movable mold 820 to touch the stationary mold 810. The position and travel speed of the crosshead 151 are detected using a mold clamping motor encoder 161 or the like. The mold clamping motor encoder 161 detects the rotation of the mold clamping motor 160 and transmits a signal indicating the detection results to the controller 700.

A crosshead position detector that detects the position of the crosshead 151 and a crosshead travel speed detector that detects the travel speed of the crosshead 151 are not limited to the mold clamping motor encoder 161 and common ones may be employed. Furthermore, a movable platen position detector that detects the position of the movable platen 120 and a movable platen travel speed detector that detects the travel speed of the movable platen 120 are not limited to the mold clamping motor encoder 161 and common ones may be employed.

In the pressurizing process, the mold clamping motor 160 is further driven to further move the crosshead 151 from the mold closing completion position to a mold clamping position, thereby generating a mold clamping force.

In the mold clamping process, the mold clamping motor 160 is driven to maintain the position of the crosshead 151 at the mold clamping position. In the mold clamping process, the mold clamping force generated in the pressurizing process is maintained. In the mold clamping process, a cavity space 801 (see FIG. 2) is formed between the movable mold 820 and the stationary mold 810, and the injection part 300 fills the cavity space 801 with a liquid molding material. The molding material is solidified, so that a molded product is obtained.

The number of cavity spaces 801 may be one or more. In the latter case, multiple molded products are simultaneously obtained. An insert material may be placed in part of the cavity space 801 and the molding material may fill another part of the cavity space 801. Thereby, a molded product into which the insert material and the molding material are integrated is obtained.

In the depressurizing process, the mold clamping motor 160 is driven to move the crosshead 151 backward from the mold clamping position to a mold opening start position to move the movable platen 120 backward to reduce the mold clamping force. The mold opening start position and the mold closing completion position may be the same position.

In the mold opening process, the mold clamping motor 160 is driven to move the crosshead 151 backward from the mold opening start position to a mold opening completion position at a set travel speed to move the movable platen 120 backward to separate the movable mold 820 from the stationary mold 810. Thereafter, the ejector 200 ejects the molded product from the movable mold 820.

Set conditions in the mold closing process, the pressurizing process, and the mold clamping process are collectively set as a series of set conditions. For example, the travel speed and positions (including a mold closing start position, a travel speed switch position, the mold closing completion position, and the mold clamping position) of the crosshead 151 and the mold clamping force in the mold closing process and the pressurizing process are collectively set as a series of set conditions. The mold closing start position, the travel speed switch position, the mold closing completion position, and the mold clamping position, which are arranged in this order in the forward direction from the back side, represent the start points and end points of sections for which the travel speed is set. The travel speed is set section by section. There may be one or more travel speed switch positions. The travel speed switch position may not be set. Only one of the mold clamping position and the mold clamping force may be set.

Setting conditions in the depressurizing process and the mold opening process are likewise set. For example, the travel speed and positions (the mold opening start position, the travel speed switch position, and the mold opening completion position) of the crosshead 151 in the depressurizing process and the mold opening process are collectively set as a series of set conditions. The mold opening start position, the travel speed switch position, and the mold opening completion position, which are arranged in this order in the backward direction from the front side, represent the start points and end points of sections for which the travel speed is set. The travel speed is set section by section. There may be one or more travel speed switch positions. The travel speed switch position may not be set. The mold opening start position and the mold closing completion position may be the same position. The mold opening completion position and the mold closing start position may be the same position.

Instead of the travel speed, position, and the like, of the crosshead 151, the travel speed, position, and the like, of the movable platen 120 may be set. Furthermore, instead of the crosshead position (e.g., the mold clamping position) or the movable platen position, the mold clamping force may be set.

The toggle mechanism 150 amplifies the driving force of the mold clamping motor 160 and transmits the amplified driving force to the movable platen 120. The amplification factor is also referred to as “toggle multiplying factor.” The toggle multiplying factor changes according to the angle θ formed by the first link 152 and the second link 153 (hereinafter also referred to as “link angle θ”). The link angle θ is determined from the position of the crosshead 151. The toggle multiplying factor is maximized when the link angle θ is 180°.

When there is a change in the thickness of the mold part 800 because of the replacement of the mold part 800 or a change in the temperature of the mold part 800, the mold thickness is adjusted to obtain a predetermined mold clamping force at the time of mold clamping. In adjusting the mold thickness, for example, the interval L between the stationary platen 110 and the toggle support 130 is adjusted so that the link angle θ of the toggle mechanism 150 becomes a predetermined angle at the time of mold touch when the movable mold 820 touches the stationary mold 810.

The mold clamping part 100 includes the mold thickness adjustment mechanism 180. The mold thickness adjustment mechanism 180 adjusts the mold thickness by adjusting the interval L between the stationary platen 110 and the toggle support 130. The mold thickness is adjusted between the end of a molding cycle and the start of the next molding cycle, for example. The mold thickness adjustment mechanism 180 includes, for example, a threaded shaft 181 formed at the rear end of each tie bar 140, a threaded nut 182 held on the toggle support 130 in such a manner as to be rotatable and impossible to move forward or backward, and a mold thickness adjustment motor 183 that rotates the threaded nut 182 mating with the threaded shaft 181.

The threaded shaft 181 and the threaded nut 182 are provided for each tie bar 140. The rotational driving force of the mold thickness adjustment motor 183 may be transmitted to the multiple threaded nuts 182 via a rotational driving force transmission part 185. It is possible to synchronously rotate the multiple threaded nuts 182. The multiple threaded nuts 182 may be individually rotated by changing the transmission channel of the rotational driving force transmission part 185.

The rotational driving force transmission part 185 is constituted of, for example, gears. In such a case, a driven gear is formed at the periphery of each threaded nut 182, a drive gear is attached to the output shaft of the mold thickness adjustment motor 183, and an intermediate gear that meshes with the driven gears and the drive gear is rotatably held in the center of the toggle support 130. The rotational driving force transmission part 185 may be constituted of a belt and pulleys instead of gears.

The operation of the mold thickness adjustment mechanism 180 is controlled by the controller 700. The controller 700 drives the mold thickness adjustment motor 183 to rotate the threaded nuts 182. As a result, the position of the toggle support 130 relative to the tie bars 140 is adjusted, and the interval L between the stationary platen 110 and the toggle support 130 is adjusted. Multiple mold thickness adjustment mechanisms may be used in combination.

The interval L is detected using a mold thickness adjustment motor encoder 184. The mold thickness adjustment motor encoder 184 detects the amount of rotation and the direction of rotation of the mold thickness adjustment motor 183, and transmits a signal indicating the detection results to the controller 700. The detection results of the mold thickness adjustment motor encoder 184 are used to monitor and control the position of the toggle support 130 and the interval L. A toggle support position detector that detects the position of the toggle support 130 and an interval detector that detects the interval L are not limited to the mold thickness adjustment motor encoder 184 and common ones may be employed.

The mold clamping part 100 may include a mold temperature adjuster that adjusts the temperature of the mold part 800. The mold part 800 contains a flow path for a temperature adjust medium. The mold temperature adjuster adjusts the temperature of the mold part 800 by adjusting the temperature of the temperature adjust medium supplied to the flow path of the mold part 800.

The mold clamping part 100, which is of a horizontal type whose mold opening and closing directions are horizontal directions according to this embodiment, may also be of a vertical type whose mold opening and closing directions are vertical directions.

The mold clamping part 100, which includes the mold clamping motor 160 as a drive source according to this embodiment, may also include a hydraulic cylinder instead of the mold clamping motor 160. Furthermore, the mold clamping part 100 may include a linear motor for mold opening and closing and may include an electromagnet for mold clamping.

### (Ejector)

In the description of the ejector 200, similar to the description of the mold clamping part 100, the direction of movement of the movable platen 120 during mold closing (e.g., the positive X-axis direction) is referred to as “forward direction”, and the direction of movement of the movable platen 120 during mold opening (e.g., the negative X-axis direction) is referred to as “backward direction.”

The ejector 200 is attached to the movable platen 120 and moves forward and backward together with the movable platen 120. The ejector 200 includes one or more ejector rods 210 that eject a molded product from the mold part 800 and a drive mechanism 220 that moves the ejector rod 210 in the directions of movement (the X-axis direction) of the movable platen 120.

Each ejector rod 210 is placed in a through hole of the movable platen 120 to be movable forward and backward. The front end of the ejector rod 210 contacts an ejector plate 826 of the movable mold 820. The front end of the ejector rod 210 may be connected to or disconnected from the ejector plate 826.

The drive mechanism 220 includes, for example, an ejector motor and a motion conversion mechanism that converts the rotational motion of the ejector motor into the linear motion of the ejector rod 210. The motion conversion mechanism includes a threaded shaft and a threaded nut that mates with the threaded shaft. Balls or rollers may be interposed between the threaded shaft and the threaded nut.

The ejector 200 executes an ejection process under the control of the controller 700. In the ejection process, the ejector rods 210 are moved forward from a standby position to an ejection position at a set travel speed to move the ejector plate 826 forward to eject a molded product. Thereafter, the ejector motor is driven to move the ejector rods 210 backward at a set travel speed to move the ejector plate 826 backward to the initial standby position.

The position and travel speed of the ejector rods 210 are detected using an ejector motor encoder, for example. The ejector motor encoder detects the rotation of the ejector motor to transmit a signal indicating the detection results to the controller 700. An ejector rod position detector that detects the position of the ejector rods 210 and an ejector rod travel speed detector that detects the travel speed of the ejector rods 210 are not limited to the ejector motor encoder and common ones may be employed.

### (Injection Part)

Unlike in the description of the mold clamping part 100 and the ejector 200, in the description of the injection part 300, the direction of movement of a screw 330 during filling (e.g., the negative X-axis direction) is referred to as “forward direction”, and the direction of movement of the screw 330 during metering (e.g., the positive X-axis direction) is referred to as “backward direction.”

The injection part 300 is installed on a slidable base 301, and the slidable base 301 is so placed as to be movable forward and backward relative to the injection part frame 920. The injection part 300 is so placed as to be movable toward and away from the mold part 800. The injection part 300 touches the mold part 800 to fill the cavity space 801 within the mold part 800 with a molding material. The injection part 300 includes, for example, a cylinder 310 that heats a molding material, a nozzle 320 provided at the front end of the cylinder 310, the screw 330 so placed in the cylinder 310 as to be movable forward and backward and rotatable, a metering motor 340 that rotates the screw 330, an injection motor 350 that moves the screw 330 forward and backward, and a load detector 360 that detects a load transmitted between the injection motor 350 and the screw 330.

The cylinder 310 heats a molding material supplied to the inside through a supply port 311. Examples of the molding material include resin. The molding material is formed into pellets, for example, and is supplied to the supply port 311 in a solid state. The supply port 311 is formed in a rear portion of the cylinder 310. A cooler 312 such as a water-cooled cylinder is provided on the outer cylindrical surface of the rear portion of the cylinder 310. First heaters 313 such as a band heater and first temperature detectors 314 are provided forward of the cooler 312 on the outer cylindrical surface of the cylinder 310.

The cylinder 310 is divided into multiple zones in the axial direction (e.g., the X-axis direction) of the cylinder 310. Each zone is provided with the first heater 313 and the first temperature detector 314. A temperature is set for each zone and the controller 700 controls the first heater 313 so that the temperature detected by the first temperature detector 314 becomes the set temperature.

The nozzle 320 is provided at the front end of the cylinder 310 to be pressed against the mold part 800. A second heater 323 and a second temperature detector 324 are provided at the periphery of the nozzle 320. The controller 700 controls the second heater 323 so that the detected temperature of the nozzle 320 becomes the set temperature.

The screw 330 is placed in the cylinder 310 to be rotatable and movable forward and backward. When the screw 330 rotates, a molding material is fed forward along the helical groove of the screw 330. The molding material is gradually melted by heat from the cylinder 310 as the molding material is fed forward. As the molding material in liquid form is fed forward on the screw 330 to be accumulated in front of the cylinder 310, the screw 330 is moved backward. Thereafter, when the screw 330 is moved forward, the molding material in liquid form accumulated in front of the screw 330 is injected into the mold part 800 through the nozzle 320.

A backflow prevention ring 331 is so attached to a front portion of the screw 330 as to be movable forward and backward as a backflow check valve that prevents the backflow of the molding material from the front to the back of the screw 330 when the screw 330 is pushed forward.

When the screw 330 is moved forward, the backflow prevention ring 331 is pushed backward by the pressure of the molding material in front of the screw 330 to move backward relative to the screw 330 to a closing position (see FIG. 2) that closes the flow channel of the molding material, thereby preventing the backflow of the molding material accumulated in front of the screw 330 in the backward direction.

When the screw 330 is rotated, the backflow prevention ring 331 is pushed forward by the pressure of the molding material fed forward along the helical groove of the screw 330 to move forward relative to the screw 330 to an open position (see FIG. 1) that opens the flow channel of the molding material. As a result, the molding material is fed forward of the screw 330.

The backflow prevention ring 331 may be of a co-rotating type that rotates together with the screw 330 or of a non-co-rotating type that does not rotate together with the screw 330.

The injection part 300 may include a drive source that moves the backflow prevention ring 331 forward and backward between the open position and the closing position relative to the screw 330.

The metering motor 340 rotates the screw 330. The drive source that rotates the screw 330 is not limited to the metering motor 340 and may be, for example, a hydraulic pump.

The injection motor 350 moves the screw 330 forward and backward. A motion conversion mechanism that converts the rotational motion of the injection motor 350 into the linear motion of the screw 330, and the like, are provided between the injection motor 350 and the screw 330. The motion conversion mechanism includes, for example, a threaded shaft and a threaded nut that mates with the threaded shaft. Balls or rollers may be provided between the threaded shaft and the threaded nut. The drive source that moves the screw 330 forward and backward is not limited to the injection motor 350, and may be, for example, a hydraulic cylinder.

The load detector 360 detects a load transmitted between the injection motor 350 and the screw 330. The detected load is converted into pressure in the controller 700. The load detector 360 is provided in the load transmission path between the injection motor 350 and the screw 330 to detect a load applied to the load detector 360.

The load detector 360 transmits a signal of the detected load to the controller 700. The load detected by the load detector 360 is converted into a pressure applied between the screw 330 and the molding material, and is used to control and monitor a pressure that the screw 330 receives from the molding material, a back pressure against the screw 330, a pressure applied from the screw 330 to the molding material, and the like.

A pressure detector that detects the pressure of a molding material is not limited to the load detector 360 and a common one may be employed. For example, a nozzle pressure sensor or a cavity pressure sensor may be employed. The nozzle pressure sensor is placed in the nozzle 320. The cavity pressure sensor is placed within the mold part 800.

The injection part 300 executes processes such as a metering process, a filling process, and a dwelling process under the control of the controller 700. The filling process and the dwelling process may be collectively referred to as “injection process.”

In a metering process, the metering motor 340 is driven to rotate the screw 330 at a set rotational speed to feed a molding material forward along the helical groove of the screw 330. With this, the molding material is gradually melted. As the molding material in liquid form is fed forward of the screw 330 to be accumulated in the front portion of the cylinder 310, the screw 330 is moved backward. The rotational speed of the screw 330 is detected using a metering motor encoder 341 or the like. The metering motor encoder 341 detects the rotation of the metering motor 340 and transmits a signal indicating the detection results to the controller 700. A screw rotational speed detector that detects the rotational speed of the screw 330 is not limited to the metering motor encoder 341 and a common one may be employed.

In the metering process, in order to restrict a sudden backward movement of the screw 330, the injection motor 350 may be driven to apply a set back pressure to the screw 330. The back pressure to the screw 330 is detected using the load detector 360, for example. When the screw 330 is moved backward to a metering completion position and a predetermined amount of molding material is accumulated in front of the screw 330, the metering process is completed.

The position and rotational speed of the screw 330 in the metering process are collectively set as a series of set conditions. For example, a metering start position, a rotational speed switch position, and the metering completion position are set. These positions, which are arranged in this order in the backward direction from the front side, represent the start points and end points of sections for which the rotational speed is set. The rotational speed is set section by section. There may be one or more rotational speed switch positions. The rotational speed switch position may not be set. Furthermore, a back pressure is set for each section.

In the filling process, the injection motor 350 is driven to move the screw 330 forward at a set travel speed to fill the cavity space 801 within the mold part 800 with the molding material in liquid form accumulated in front of the screw 330. The position and travel speed of the screw 330 are detected using an injection motor encoder 351, for example. The injection motor encoder 351 detects the rotation of the injection motor 350 and transmits a signal indicating the detection results to the controller 700. When the position of the screw 330 reaches a set position, the filling process switches to the dwelling process (so-called V/P switchover). The position at which V/P switchover occurs may be referred to as “V/P switchover position.” The set travel speed of the screw 330 may be changed according to the position of the screw 330, time, and the like.

The position and travel speed of the screw 330 in the filling process are collectively set as a series of set conditions. For example, a filling start position (also referred to as “injection start position”), a travel speed switch position, and the V/P switchover position are set. These positions, which are arranged in this order in the forward direction from the back side, represent the start points and end points of sections for which the travel speed is set. The travel speed is set section by section. There may be one or more travel speed switch positions. The travel speed switch position may not be set.

The upper limit of the pressure of the screw 330 is set for each section for which the travel speed of the screw 330 is set. The pressure of the screw 330 is detected by the load detector 360. When the pressure of the screw 330 is less than or equal to a set pressure, the screw 330 is moved forward at a set travel speed. When the pressure of the screw 330 exceeds the set pressure, the screw 330 is moved forward at a travel speed lower than the set travel speed so that the pressure of the screw 330 is less than or equal to the set pressure, for mold protection.

In the filling process, after the position of the screw 330 reaches the V/P switchover position, the screw 330 may be temporarily stopped at the V/P switchover position and the V/P switchover may be thereafter performed. Immediately before the V/P switchover, the screw 330 may be moved forward or backward very slowly instead of being stopped. A screw position detector that detects the position of the screw 330 and a screw travel speed detector that detects the travel speed of the screw 330 are not limited to the injection motor encoder 351 and common ones may be employed.

In the dwelling process, the injection motor 350 is driven to push the screw 330 forward to hold the pressure of the molding material at the front end of the screw 330 (hereinafter also referred to as “dwell pressure”) at a set pressure and press the molding material remaining in the cylinder 310 toward the mold part 800. It is possible to compensate for a shortage of molding material due to cooling contracture within the mold part 800. The dwell pressure is detected using the load detector 360, for example. The set value of the dwell pressure may be changed in accordance with the time elapsed from the start of the dwelling process or the like. Two or more values may be set for each of the dwell pressure and the dwell time for holding the dwell pressure in the dwelling process, and the dwell pressure and the dwell time may be collectively set as a series of set conditions.

In the dwelling process, the molding material in the cavity space 801 within the mold part 800 is gradually cooled, so that the entrance of the cavity space 801 is filled up with the solidified molding material when the dwelling process is completed. This state, which is referred to as “gate seal,” prevents the backflow of the molding material from the cavity space 801. After the dwelling process, a cooling process is started. In the cooling process, the molding material in the cavity space 801 is solidified. The metering process may be executed during the cooling process in order to reduce molding cycle time.

The injection part 300, which is of an in-line screw type according to this embodiment, may be of a screw pre-plasticizing type. According to the screw pre-plasticizing injection part, a molding material melted in a plasticizing cylinder is supplied to an injection cylinder, and the molding material is injected into a mold part from the injection cylinder. In the plasticizing cylinder, a screw is so placed as to be rotatable and immovable forward or backward or a screw is so placed as to be rotatable and movable forward and backward. In the injection cylinder, a plunger is so placed as to be movable forward and backward.

Furthermore, the injection part 300, which is of a horizontal type where the axial direction of the cylinder 310 is a horizontal direction according to this embodiment, may be of a vertical type where the axial direction of the cylinder 310 is a vertical direction. A mold clamping part combined with the injection part 300 of a vertical type may be of a horizontal type or a vertical type. Likewise, a mold clamping part combined with the injection part 300 of a horizontal type may be of a horizontal type or a vertical type.

### (Moving Part)

In the description of the movement part 400, similar to the description of the injection part 300, the direction of movement of the screw 330 during filling (e.g., the negative X-axis direction) is referred to as “forward direction”, and the direction of movement of the screw 330 during metering (e.g., the positive X-axis direction) is referred to as “backward direction.”

The movement part 400 moves the injection part 300 toward and away from the mold part 800. Furthermore, the movement part 400 presses the nozzle 320 against the mold part 800 to generate a nozzle touch pressure. The movement part 400 includes a hydraulic pump 410, a motor 420 serving as a drive source, and a hydraulic cylinder 430 serving as a hydraulic actuator.

The hydraulic pump 410 includes a first port 411 and a second port 412. The hydraulic pump 410, which is a bidirectionally rotatable pump, switches the rotational direction of the motor 420 to take in hydraulic fluid (e.g., oil) from one of the first port 411 and the second port 412 and discharge hydraulic fluid from the other of the first port 411 and the second port 412, thereby generating hydraulic pressure. The hydraulic pump 410 may take in hydraulic fluid from a tank and discharge hydraulic fluid from one of the first port 411 and the second port 412.

The motor 420 causes the hydraulic pump 410 to operate. The motor 420 drives the hydraulic pump 410 with a rotational direction and a rotation torque corresponding to a control signal from the controller 700. The motor 420 may be an electric motor and may be an electric servo motor.

The hydraulic cylinder 430 includes a cylinder body 431, a piston 432, and a piston rod 433. The cylinder body 431 is fixed to the injection part 300. The piston 432 separates the inside of the cylinder body 431 into a front chamber 435 serving as a first chamber and a rear chamber 436 serving as a second chamber. The piston rod 433 is fixed to the stationary platen 110.

The front chamber 435 of the hydraulic cylinder 430 is connected to the first port 411 of the hydraulic pump 410 via a first flow channel 401. Hydraulic fluid discharged from the first port 411 is supplied to the front chamber 435 via the first flow channel 401 to push the injection part 300 forward. The injection part 300 is moved forward to press the nozzle 320 against the stationary mold 810. The front chamber 435 serves as a pressure chamber that generates the nozzle touch pressure of the nozzle 320 with the pressure of the hydraulic fluid supplied from the hydraulic pump 410.

The rear chamber 436 of the hydraulic cylinder 430 is connected to the second port 412 of the hydraulic pump 410 via a second flow channel 402. Hydraulic fluid discharged from the second port 412 is supplied to the rear chamber 436 of the hydraulic cylinder 430 via the second flow channel 402 to push the injection part 300 backward. The injection part 300 is moved backward to separate the nozzle 320 from the stationary mold 810.

According to this embodiment, the movement part 400 includes the hydraulic cylinder 430. The present disclosure, however, is not limited to this. For example, instead of the hydraulic cylinder 430, an electric motor and a motion conversion mechanism that converts the rotational motion of the electric motor into the linear motion of the injection part 300 may be employed.

### (Controller)

The controller 700, which is composed of, for example, a computer, includes a central processing unit (CPU) 701, a storage medium 702 such as a memory, an input interface (I/F) 703, and an output interface (I/F) 704 as illustrated in FIG. 1 and FIG. 2. The controller 700 executes various controls by causing the CPU 701 to execute one or more programs stored in the storage medium 702. Furthermore, the controller 700 receives an external signal at the input interface 703 and transmits a signal to the outside at the output interface 704.

The controller 700 repeatedly produces a molded product by repeatedly executing processes such as the metering process, the mold closing process, the pressurizing process, the mold clamping process, the filling process, the dwelling process, the cooling process, the depressurizing process, the mold opening process, and the ejection process. A series of operations for obtaining a molded product, for example, operations from the start of a metering process and the start of the next metering process, may be referred to as “shot” or “molding cycle.” Furthermore, time required for one shot may be referred to as “molding cycle time” or “cycle time.”

One molding cycle has, for example, the metering process, the mold closing process, the pressurizing process, the mold clamping process, the filling process, the dwelling process, the cooling process, the depressurizing process, the mold opening process, and the ejection process in this order. The order here is order in which the processes are started. The filling process, the dwelling process, and the cooling process are executed during the mold clamping process. The start of the mold clamping process may coincide with the start of the filling process. The completion of the depressurizing process coincides with the start of the mold opening process.

Multiple processes may be simultaneously executed to reduce the molding cycle time. For example, the metering process may be executed during the cooling process of the previous molding cycle or may be executed during the mold clamping process. In such a case, the mold closing process may be executed at the beginning of the molding cycle. Furthermore, the filling process may be started during the mold closing process. Furthermore, the ejection process may be started during the mold opening process. When an on-off valve that opens and closes the flow path of the nozzle 320 is provided, the mold opening process may be started during the metering process. This is because even when the mold opening process is started during the metering process, no molding material leaks from the nozzle 320 as long as the on-off valve closes the flow path of the nozzle 320.

One molding cycle may include one or more processes other than the metering process, the mold closing process, the pressurizing process, the mold clamping process, the filling process, the dwelling process, the cooling process, the depressurizing process, the mold opening process, and the ejection process.

For example, before the start of the metering process after the completion of the dwelling process, a pre-metering suck back process to move the screw 330 backward to a preset metering start position may be executed. This makes it possible to reduce the pressure of the molding material accumulated in front of the screw 330 before the start of the metering process and to prevent a sudden backward movement of the screw 330 at the start of the metering process.

Furthermore, before the start of the filling process after the completion of the metering process, a post-metering suck back process to move the screw 330 backward to a preset filling start position (also referred to as “injection start position”) may be executed. This makes it possible to reduce the pressure of the molding material accumulated in front of the screw 330 before the start of the filling process and to prevent the leakage of the molding material from the nozzle 320 before the start of the filling process.

The controller 700 is connected to an operation device 750 that receives an input operation from a user and a display device 760 that displays a screen. The display device includes a circuit and the like. The operation device 750 and the display device 760 may be composed of, for example, a touchscreen 770 as a one-piece structure. The touchscreen 770 serving as the display device 760 displays a screen under the control of the controller 700. For example, information such as the settings of the injection molding machine 10 and the current condition of the injection molding machine 10 may be displayed on the screen of the touchscreen 770. For example, operation parts such as buttons and input fields for receiving a user's input operation may be displayed on the screen of the touchscreen 770. The touchscreen 770 serving as the operation device 750 detects a user's input operation on the screen and outputs a signal according to the input operation to the controller 700. This enables the user to, for example, enter the settings (including setting values) for the injection molding machine 10 by operating the operation parts provided on the screen while checking information displayed on the screen. Furthermore, by operating the operation parts provided on the screen, the user can cause the injection molding machine 10 to perform operations corresponding to the operation parts. The operations of the injection molding machine 10 may be, for example, the operations (including stopping) of the mold clamping part 100, the ejector 200, the injection part 300, the movement part 400, and the like. Furthermore, the operations of the injection molding machine 10 may be, for example, the switching of the screen displayed on the touchscreen 770 serving as the display device 760.

The operation device 750 and the display device 760 of this embodiment, which are described as being integrated into the touchscreen 770, may be separately provided. Furthermore, two or more operation devices 750 may be provided. The operation device 750 and the display device 760 are disposed on the operation side (the negative side in the Y-axis direction) of the mold clamping part 100 (more specifically, the stationary platen 110).

### (Details of Controller)

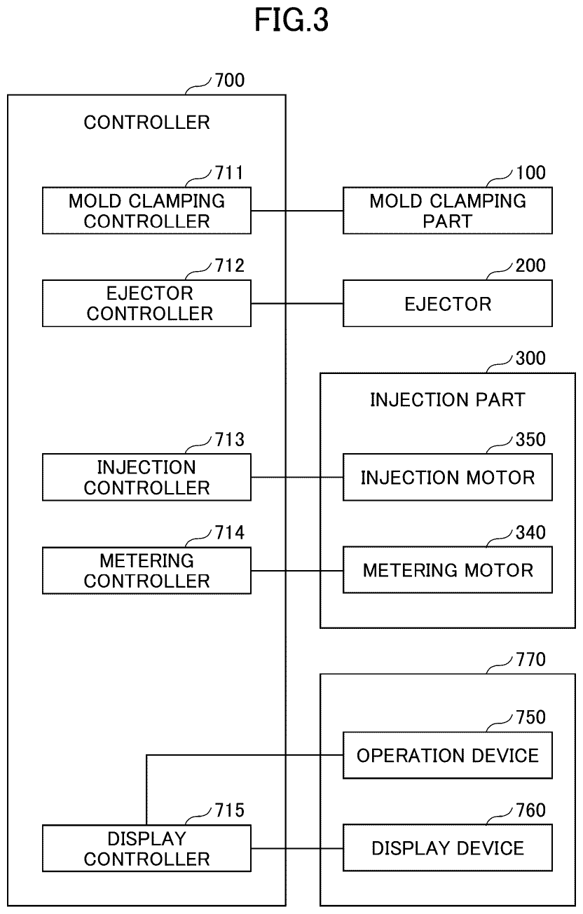

Next, an example of the components of the controller 700 will be described with reference to FIG. 3. The functional blocks illustrated in FIG. 3 are conceptual and do not have to be physically configured as illustrated. All or some of the functional blocks may be functionally or physically distributed or integrated in desired parts. Processing functions executed in the functional blocks are entirely or partly as desired executed by one or more programs executed in a CPU. Alternatively, the functional blocks may be realized as hardware by wired logic.

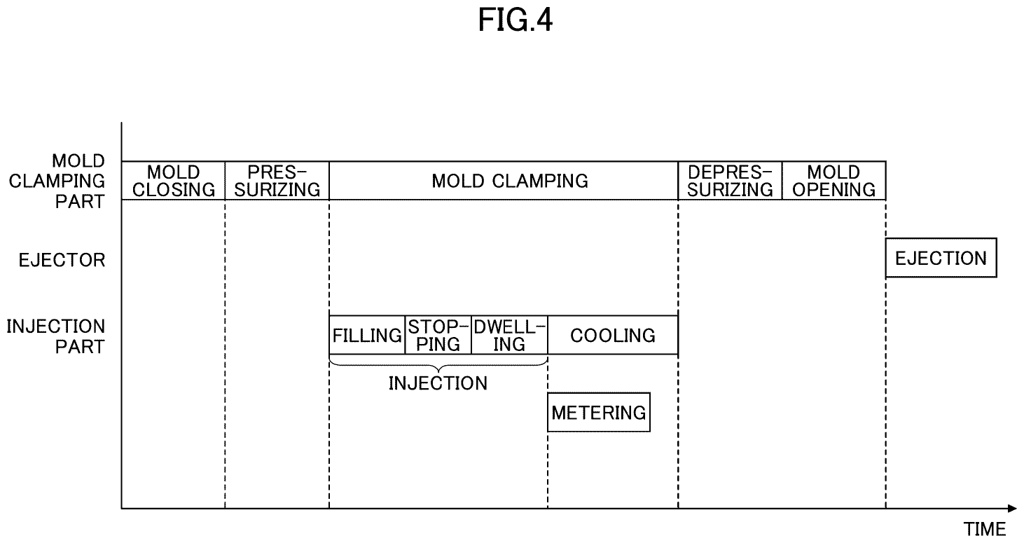

As illustrated in FIG. 3, the controller 700 includes, for example, a mold clamping controller 711, an ejector controller 712, an injection controller 713, a metering controller 714, and a display controller 715. The mold clamping controller 711 is configured to control the mold clamping part 100, and perform the mold closing process, the pressurizing process, the mold clamping process, the depressurizing process, and the mold opening process illustrated in FIG. 4. The ejector controller 712 is configured to control the ejector 200, and perform the ejection process.

The injection controller 713 is configured to control an injection drive source of the injection part 300, and perform the injection process. The injection drive source is the injection motor 350 in this embodiment, but may be a hydraulic cylinder or the like. The injection process is performed during the mold clamping process as illustrated in FIG. 4. The injection controller 713 controls the movement of the injection member. The injection member is provided inside the cylinder 310, and injects the molding material from the cylinder 310 to the mold part 800. The injection member is the screw 330 in this embodiment, but may be a plunger.

The injection controller 713 monitors the actual value of the travel speed of the screw 330. The travel speed of the screw 330 is detected using a speed detector. The speed detector is, for example, the injection motor encoder 351. The injection controller 713 monitors the actual value of the pressure applied from the screw 330 to the molding material. The pressure is detected using a pressure detector, such as the load detector 360 or the like. As the pressure detector, a nozzle pressure sensor or a cavity pressure sensor may be employed. The injection process sequentially includes the filling process, the stopping process, and the dwelling process as illustrated in FIG. 4.

In the filling process, by causing the screw 330 to travel forward, the mold part 800 is filled with the molding material in liquid form accumulated in the front of the screw 330. In the filling process, for example, the injection motor 350 is controlled so that an actual value of the travel speed of the screw 330 provided in the cylinder 310 becomes a set value. In the filling process, in response to the screw 330 traveling forward, the actual value of the pressure applied from the screw 330 to the molding material increases.

In the stopping process, the travel of the screw 330 is stopped. The time of the stopping process is set in advance. In the stopping process, the molding material flows into the mold part 800 by the action of the residual pressure. By utilizing the residual pressure, an excessive increase in the pressure can be suppressed, and molding failures, such as burrs and the like, can be suppressed. In addition, the mold clamping force can be reduced. When the time elapsed from the start of the stopping process reaches a preset time, switching from the stopping process to the dwelling process is performed.

In the dwelling process, by pushing the screw 330 forward, a shortage of molding material due to cooling contracture within the mold part 800 is compensated for. In the dwelling process, for example, the injection motor 350 is controlled so that an actual value of the pressure applied from the screw 330 to the molding material becomes a set value.

The metering controller 714 is configured to control a metering drive source of the injection part 300, and perform the metering process. The metering drive source is the metering motor 340 in this embodiment, but may be a hydraulic pump or the like. The metering process is preferably performed during the cooling process as illustrated in FIG. 4 in order to reduce the molding cycle time. The cooling process is started after completion of the dwelling process. The cooling process performs solidification of the molding material in the cavity space 801.

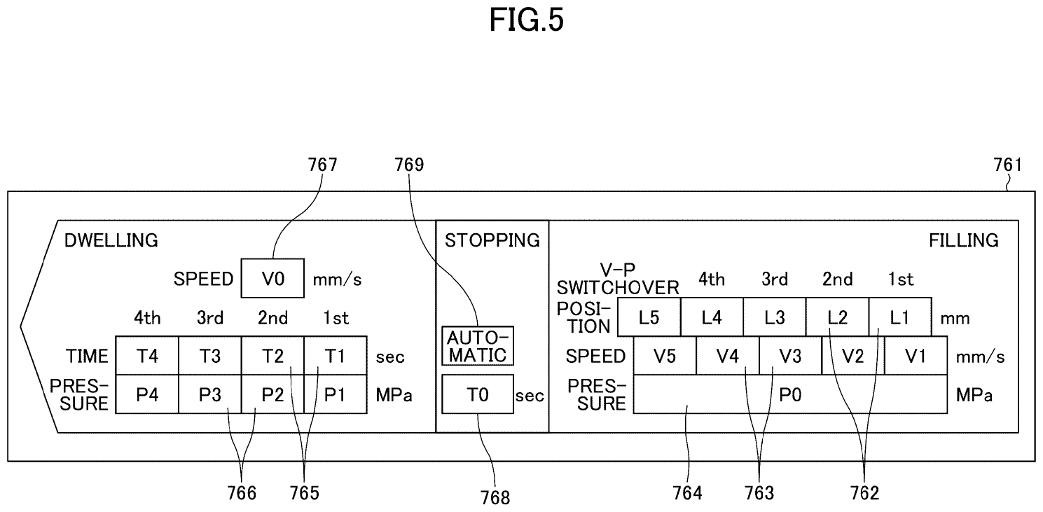

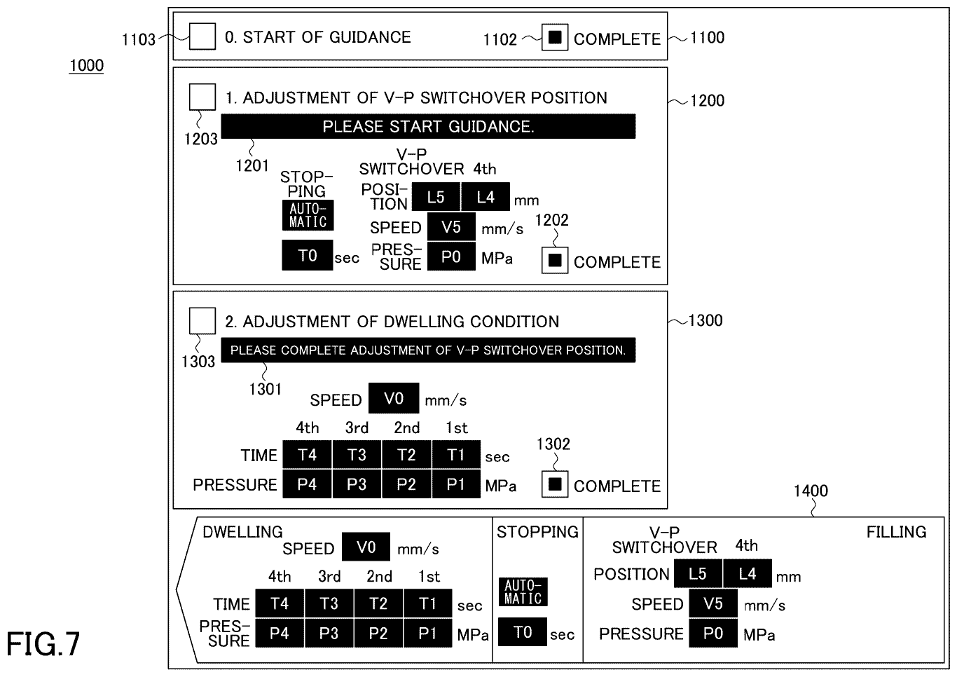

The display controller 715 is configured to control the display device 760. The display controller 715 performs switching of the screen displayed on the display device 760 in accordance with an input operation in the operation device 750. For example, the display controller 715 displays a setting screen 761 as illustrated in FIG. 5 on the display device 760. The display controller 715 displays a guidance screen 1000 as illustrated in FIG. 7 to FIG. 11 on the display device 760, although details thereof will be described below.

Next, an example of the setting screen 761 of the injection process will be described with reference to FIG. 5. The setting screen 761 includes input sections 762 to 769 each configured to receive an input of a condition of the injection process. A user operates the operation device 750 while checking the setting screen 761, thereby inputting the conditions to the input sections 762 to 769. The input sections 762 to 769 display the conditions input to the input sections 762 to 769 as numbers, characters, or symbols. The symbols include graphic symbols.

First, a setting field of the filling process will be described. The conditions of the filling process are input to the input sections 762, 763, and 764. Set values L1 to L5 of the position of the screw 330 are input to the input sections 762. The position of the screw 330 is expressed, for example, as a distance from a position that is the mechanical advance limit of the screw 330. Set values V1 to V5 of the travel speed of the screw 330 are input to the input sections 763. A set value P0 of the pressure applied from the screw 330 to the molding material is input to the input section 764.

In the filling process, the injection controller 713 feedback-controls the injection motor 350 so that an actual value of the travel speed of the screw 330 becomes the set value (e.g., V1) until the actual value of the position of the screw 330 reaches the set value (e.g., L1). The injection controller 713 may also correct the set value of the travel speed and the like so that the actual value of the pressure applied from the screw 330 to the molding material does not exceed the set value (e.g., P0).

In order to enable inputting the combination of the position and the travel speed in the filling process at, for example, up to five steps, five sets of the vertically aligned pair of input sections 762 and 763 are laterally aligned, for example. Set values L1 to L4 of the travel speed switch position are input to four of the input sections 762. A set value L5 of the V/P switchover position is input to the remaining input section 762. Set values V1 to V5 of the travel speed are input to the five input sections 763. The number of the sets of the input sections 762 and 763 is not limited to five.

When the number of the sets of the input sections 762 and 763 is five, not all of the five sets of the input sections 762 and 763 may be used. To the input sections 762 and 763 that are not used, characters expressing being not used, such as “OFF” or the like, are input. Being not used may be expressed with symbols or blanks rather than the characters.

From the beginning of the filling process to the end of the filling process, the travel speed of the screw 330 may not be switched, and the travel speed of the screw 330 may be constant. In this case, only the combination of the set value L5 of the V/P switchover position and the set value V5 of the travel speed until the V/P switchover position may be input. When the actual value of the position of the screw 330 has reached the set value L5 of the V/P switchover position, the injection controller 713 performs switching from the filling process to the stopping process.

Next, before describing a setting field of the stopping process, a setting field of the dwelling process will be described. The conditions of the dwelling process are input to input sections 765, 766, and 767. Set values T1 to T4 of the dwell time for holding the pressure applied from the screw 330 to the molding material are input to the input sections 765. Set values P1 to P4 of the pressure applied from the screw 330 to the molding material are input to the input sections 766. A set value V0 of the travel speed of the screw 330 is input to the input section 767.

In the dwelling process, the injection controller 713 feedback-controls the injection motor 350 so that the actual value of the pressure becomes a set value (e.g., P1) until the actual value of the dwell time reaches a set value (e.g., T1). The injection controller 713 may correct, for example, the set value of the pressure so that the travel speed (forward or backward travel speed) of the screw 330 does not exceed the set value (e.g., V0). The input section 767 to which the set value of the forward travel speed is input and the input section 767 to which the set value of the backward travel speed is input may be separately provided.

In order to enable setting the combination of the dwell time and the pressure in the dwelling process at, for example, up to four steps, four sets of the vertically aligned pair of input sections 765 and 766 are laterally aligned, for example. The number of the sets of the input sections 765 and 766 is not limited to four. When the number of the sets of the input sections 765 and 766 is four, not all of the four sets of the input sections 765 and 766 may be used. From the beginning of the dwelling process to the end of the dwelling process, the pressure may not be switched, and the pressure may be constant. In this case, only one set of the combinations of the set value of the pressure and the set value of the dwell time may be input.

Next, the setting field of the stopping process will be described. Conditions of the stopping process are input to the input sections 768 and 769. A set value TO of the time of the stopping process is input to the input section 768. A choice of whether or not to perform switching from the stopping process to the dwelling process at an automatically set timing is input to the input section 769.

The input section 769 displays multiple candidates, for example, as a pull-down menu. The multiple candidates are, for example, “AUTOMATIC” and “MANUAL”. The user chooses one candidate from the multiple candidates. The input section 769 may be a changeover switch rather than a pull-down menu. Every time the user presses the changeover switch, the choice may be changed and the display may be changed.

For example, when the display of the input section 769 is “MANUAL,” the injection controller 713 performs switching from the stopping process to the dwelling process in accordance with the set value TO input by the user. Specifically, once the actual value of the time elapsed from the start of the stopping process reaches the set value TO, the injection controller 713 performs switching from the stopping process to the dwelling process. Meanwhile, for example, when the display of the input section 769 is “AUTOMATIC,” the injection controller 713 performs switching from the stopping process to the dwelling process at an automatically set timing.

A method of automatically setting the time of the stopping process may be a common method without any particular limitation. For example, the time of the filling process may be set to 100% and a specific percentage relative thereto may be set as the time of the stopping process. The time of the filling process may be measured by, for example, a timer. The time of the filling process may be measured for each shot. The time of the filling process may be an average of most-recent multiple shots.

In order to provide the conditions of the injection process, test molding is performed. Existing test molding is performed repeatedly while changing the conditions of the injection process using the setting screen 761 as illustrated in FIG. 5. Conditions upon completion of the filling process are provided so that the molding material flows into the mold part 800 by the action of the residual pressure in the stopping process. The conditions upon completion of the filling process include, for example, the position of the screw 330 (so-called V/P switchover position), the travel speed of the screw 330, and the upper limit of the pressure applied from the screw 330 to the molding material.

In this embodiment, in order for even lower skilled users to enable providing conditions of the injection process that can produce the effect of the stopping process, the display controller 715 displays the guidance screen 1000 as illustrated in FIG. 7 to FIG. 11 on the display device 760. The guidance screen 1000 assists in providing conditions of the injection process. The guidance screen 1000 includes, for example, a preparation field 1100, a first input field 1200, a second input field 1300, and a display field 1400. It is enough that the guidance screen 1000 includes at least the first input field 1200.

The preparation field 1100, the first input field 1200, the second input field 1300, and the display field 1400 are preferably arranged in this order from top to bottom. With this arrangement, the user readily understands the order of using these fields. The user first uses the preparation field 1100 to confirm that the preparation for providing conditions of the injection process is completed. Next, the user uses the first input field 1200 to perform providing conditions of the filling process. Finally, the user uses the second input field 1300 to provide conditions of the dwelling process. The display field 1400 is used to confirm the result of providing conditions of the injection process.

The preparation field 1100 may include a complete button 1102. Until the complete button 1102 is pressed, the controller 700 prohibits providing conditions using the first input field 1200 and the second input field 1300. Also, until the complete button 1102 is pressed, the controller 700 may prohibit any input operation to the first input field 1200 and the second input field 1300.

The controller 700 monitors whether or not the complete button 1102 of the preparation field 1100 is pressed. When the complete button 1102 is pressed, the controller 700 determines whether or not the full-automatic operation is ended. The full-automatic operation is an operation in which the molding cycle is automatically repeated. When the full-automatic operation is being performed, the controller 700 displays a warning on the display 760. This can inform the user that the preparation is not completed.

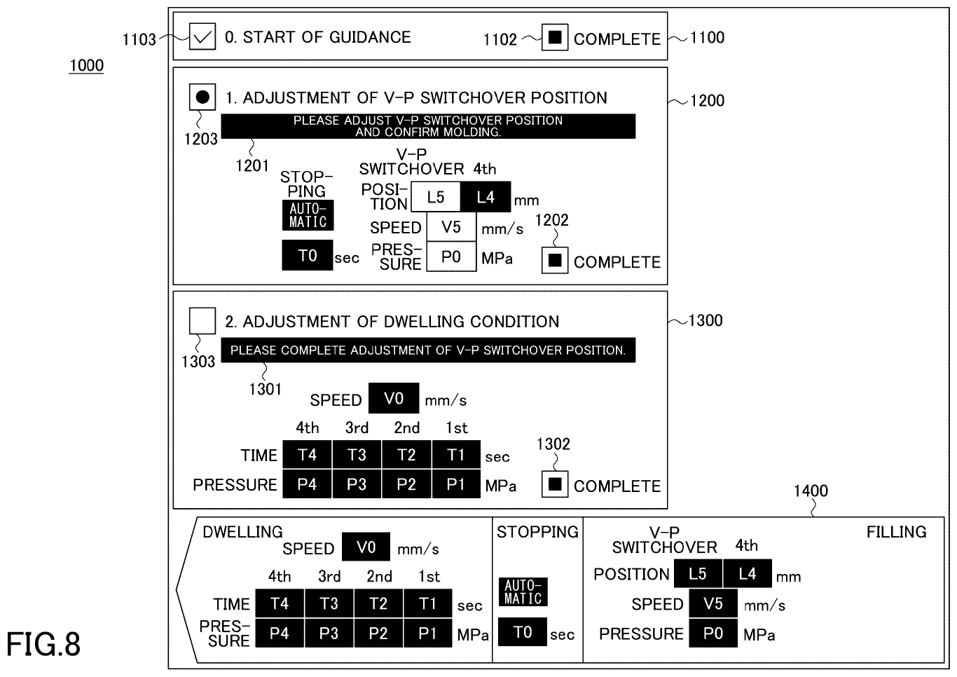

The preparation field 1100 may include a display section 1103. The display section 1103 displays the progress of the preparation. The progress is displayed, for example, by a symbol. A blank displayed in the display section 1103 as illustrated in FIG. 7 indicates that the preparation is not completed. A check mark displayed in the display section 1103 as illustrated in FIG. 8 indicates that the preparation is completed.

The first input field 1200 is configured to receive an input of conditions upon completion of the filling process in the first test molding. For example, as illustrated in FIG. 8, the first input field 1200 is configured to receive an input of the set value L5 of the V/P switchover position, the set value V5 of the travel speed until the V/P switchover position, and the set value P0 of the upper limit of the pressure until the V/P switchover position. L5, V5, P0, or any combination thereof can be updated.

As illustrated in FIG. 8, parts where the conditions can be input and parts where the conditions cannot be input may be displayed in different manners, and for example, the color of the backgrounds and the color of the characters may be reversed. In the first input field 1200, the conditions other than the conditions upon completion of the filling process may be impossible to input. However, the conditions that cannot be input may be displayed in the first input field 1200. For example, the first input field 1200 may display the set value L4 of the speed switching position immediately before the V/P switchover position in order to assist in providing the condition of the V/P switchover position.

In the first test molding, the filling process is performed under the conditions input to the first input field 1200, and subsequently the stopping process is performed. In the first test molding, the setting of the stopping process may be “AUTOMATIC.” In the first test molding, after the stopping process, the dwelling process is performed under conditions that will be described below. In the first test molding, the conditions of the dwelling process are conditions that enable confirming the forward flow end position of the molding material upon completion of the stopping process.

In the first test molding, the conditions of the dwelling process preferably include the pressure applied from the screw 330 to the molding material being approximately zero. When the pressure in the dwelling process is approximately zero, the forward flow end position of the molding material upon completion of the stopping process can be confirmed even after the dwelling process because of approximately no change in the forward flow end position of the molding material in the dwelling process.

The pressure in the dwelling process of the first test molding may be as desired, as long as the pressure is within a range in which the forward flow end position of the molding material upon completion of the stopping process can be confirmed. The pressure in the dwelling process of the first test molding may not be completely zero. The pressure in the dwelling process of the first test molding can vary with the shape and dimensions of the molded product and the type of resin.

The pressure in the dwelling process of the first test molding is preferably 3% or lower than the peak pressure during mass production (full-automatic operation) of the molded product. The pressure in the dwelling process of the first test molding is preferably from 0.0 MPa through 1.5 MPa. When this pressure is 0.0 MPa, the screw 330 pushes the molding material so that the pressure becomes 0.0 MPa.

In the dwelling process of the first test molding, the set values P1 to P4 of the pressure input in the setting screen 761 as illustrated in FIG. 5 are ignored. Alternatively, corrected values obtained by reducing the set values P1 to P4 to 3% or lower than the peak pressure are used. The set values T1 to T4 of the dwell time are used as they are in the dwelling process of the first test molding.

According to this embodiment, the user of the injection molding machine 10 can repeatedly perform the first test molding while gradually advancing the V/P switchover position, thereby providing the conditions upon completion of the filling process so that the forward flow end position of the molding material upon completion of the stopping process becomes a desired position. Thereby, the conditions upon completion of the filling process can be provided so that the molding material flows into the mold part 800 by the action of the residual pressure in the stopping process. When the forward end of the molding material in the flowing direction thereof does not reach the end of the cavity space 801 upon completion of the filling process, the effect of the stopping process can be obtained.

The first input field 1200 may include a display section 1201. The display section 1201 displays the contents of the next operation to be executed by the user in order to proceed with providing conditions using the first input field 1200. The first input field 1200 may include a complete button 1202. Until the complete button 1202 is pressed, the controller 700 prohibits providing conditions using the second input field 1300. Also, until the complete button 1202 is pressed, the controller 700 may prohibit any input operation to the second input field 1300.

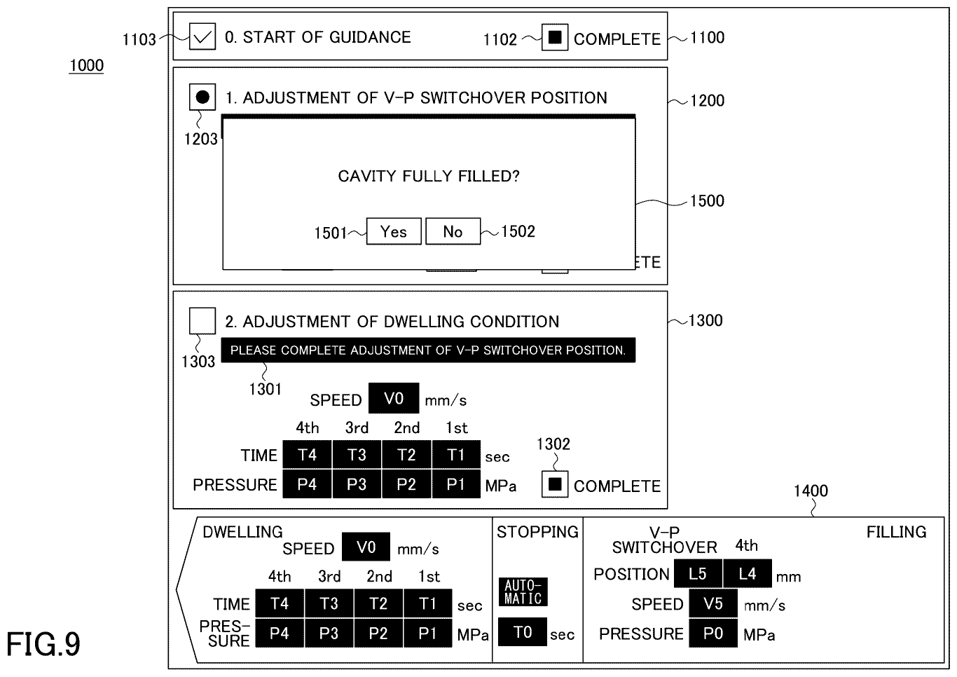

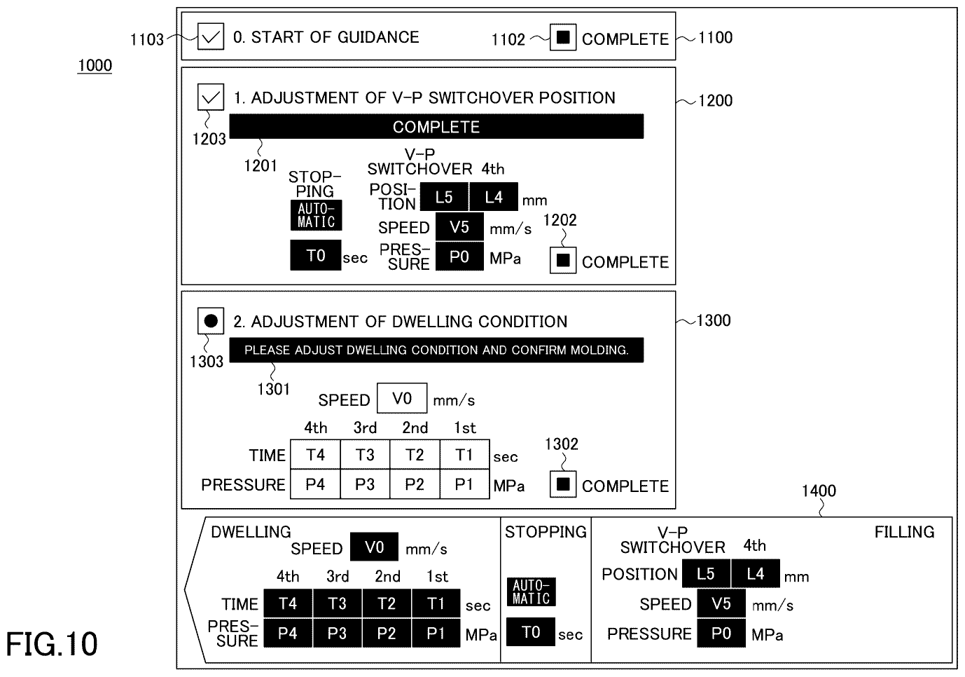

The first input field 1200 may include a display section 1203. The display section 1203 displays the progress of providing conditions using the first input field 1200. The progress is displayed, for example, by a symbol. A blank displayed in the display section 1203 as illustrated in FIG. 7 indicates that providing conditions using the first input field 1200 has not started. A circle mark displayed in the display section 1203 as illustrated in FIG. 8 and FIG. 9 indicates that providing conditions using the first input field 1200 is in progress. A check mark displayed in the display section 1203 as illustrated in FIG. 10 indicates that providing conditions using the first input field 1200 is completed.

The second input field 1300 is configured to receive an input of conditions of the dwelling process in a second test molding performed after the first test molding. For example, as illustrated in FIG. 10, the second input field 1300 is configured to receive an input of the set values T1 to T4 of the dwell time and the set values P1 to P4 of the pressure. The second input field 1300 may be configured to receive an input of the set value V0 of the travel speed of the screw 330. T1 to T4, P1 to P4, V0, or any combination thereof can be updated.

In the second test molding, the filling process is performed under the conditions input to the first input field 1200 and subsequently the stopping process is performed, and then the dwelling process is performed under the conditions input to the second input field 1300. In the second test molding, the setting of the stopping process may be “AUTOMATIC” like in the first test molding.

According to this embodiment, after the user of the injection molding machine 10 completes providing conditions upon completion of the filling process through the first test molding, the user can repeatedly perform the second test molding while changing the conditions of the dwelling process, thereby providing conditions of the dwelling process so as to produce a molded product having a desired quality. Because providing conditions upon completion of the filling process is completed before providing conditions of the dwelling process, the effect of the stopping process can be obtained.

The second input field 1300 may include a display section 1301. The display section 1301 displays the contents of the next operation to be executed by the user in order to proceed with providing conditions using the second input field 1300. The second input field 1300 may include a complete button 1302. Also, until the complete button 1302 is pressed, the controller 700 may prohibit mass production (full-automatic operation) of the molded product.

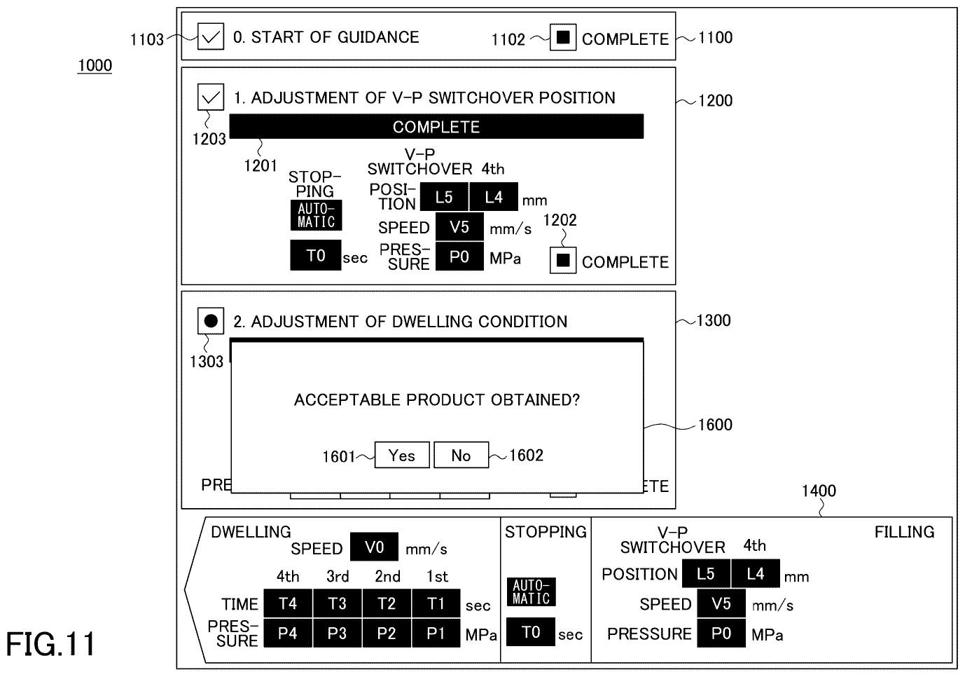

The second input field 1300 may include a display section 1303. The display section 1303 displays the progress of providing conditions using the second input field 1300. The progress is displayed, for example, by a symbol. A blank displayed in the display section 1303 as illustrated in FIG. 7 to FIG. 9 indicates that providing conditions using the second input field 1300 is not started. A circle mark displayed in the display section 1303 as illustrated in FIG. 10 and FIG. 11 indicates that providing conditions using the second input field 1300 is in progress. Although not illustrated, a check mark displayed in the display section 1303 indicates that providing conditions using the second input field 1300 is completed.

Apart from the first input field 1200 and the second input field 1300, the display field 1400 collectively displays the conditions input to the first input field 1200 and the second input field 1300. By checking the display field 1400, the user can collectively understand the conditions of the filling process and the conditions of the dwelling process.

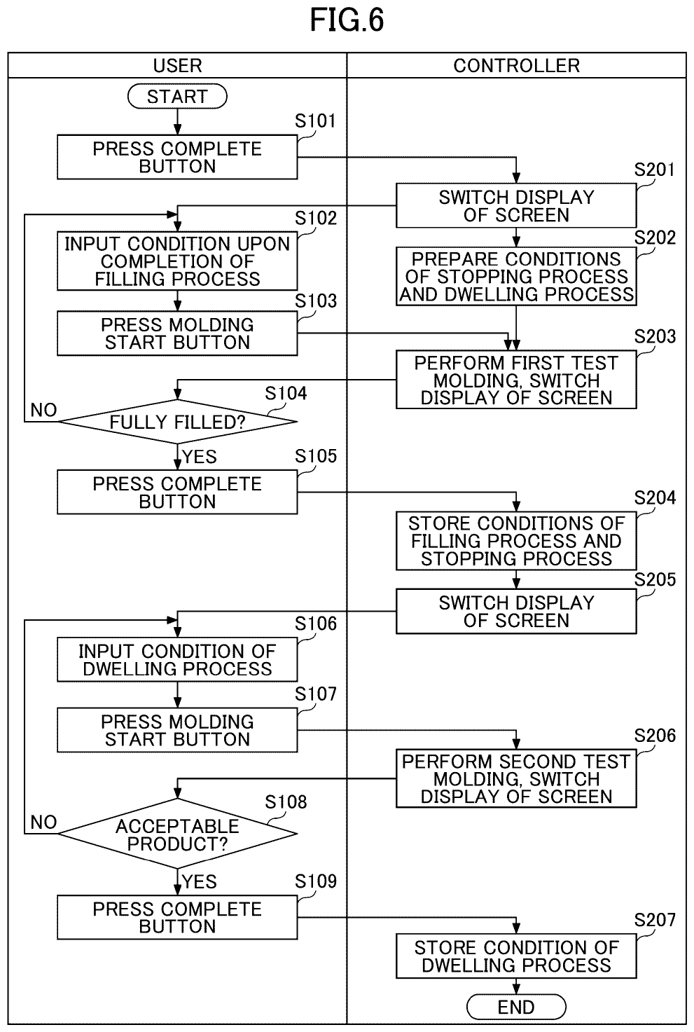

An example of setting of the injection process using the guidance screen 1000 will be described below with reference to FIG. 6 to FIG. 11. The process subsequent to step S101 as illustrated in FIG. 6 is started when the display device 760 displays the initial screen of the guidance screen 1000. The initial screen of the guidance screen 1000 is, for example, the screen as illustrated in FIG. 7.

The user of the injection molding machine 10 presses the complete button 1102 of the preparation field 1100 (step S101). When the controller 700 determines that the complete button 1102 of the preparation field 1100 is pressed, the controller 700 determines whether or not the full-automatic operation is ended. When the full-automatic operation is being performed, the controller 700 displays a warning on the display device 760. This can inform the user that the preparation is not completed.

When the complete button 1102 of the preparation field 1100 is pressed and the full-automatic operation is ended, the control device 700 performs switching of the display of the guidance screen 1000 as illustrated in FIG. 8 (step S201). A mark indicating that the preparation is completed is displayed in the display section 1103 of the preparation field 1100. In the display field 1203 of the first input field 1200, a mark indicating that providing conditions using the first input field 1200 is in progress is displayed. In addition, in the display section 1201 of the first input field 1200, the contents of the next operation to be executed by the user are displayed.

The user inputs the conditions upon completion of the filling process in the first test molding (step S102). For example, the user inputs the set value L5 of the V/P switchover position, the set value V5 of the travel speed until the V/P switchover position, the set value P0 of the upper limit of the pressure until the V/P switchover position, or any combination thereof.

Next, in order to execute the first test molding, the user presses an unillustrated molding start button (step S103). Although the molding start button is not included in the guidance screen 1000 in this embodiment, the molding start button may be included in the guidance screen 1000. The molding start button may be a software switch (switch displayed on the screen) or may be a hardware switch (switch having a contact).

While the user performs step S102 and step S103, the controller 700 prepares conditions of the stopping process and the dwelling process (step S202). Subsequently, when the controller 700 determines that the molding start button is pressed, the controller 700 performs the first test molding and performs switching of the display of the guidance screen 1000 as illustrated in FIG. 9 (step S203). The guidance screen 1000 includes a first determination field 1500.

The first determination field 1500 is displayed as a pop-up display so as to overlap the first input field 1200 in this embodiment. However, the first determination field 1500 may be always displayed in a dedicated area. The first determination field 1500 is configured to receive an input indicating that the forward flow end position of the molding material upon completion of the stopping process reaches a desired position in the first test molding. For example, the first determination field 1500 includes option buttons 1501 and 1502. In place of the option buttons 1501 and 1502, a check box may be provided.

The user checks the molded product removed from the mold part 800 after the first test molding and determines whether or not the forward flow end position of the molding material upon completion of the stopping process reaches a desired position in the first test molding (step S104). The user inputs the determination result to the first determination field 1500. In the first test molding, because the pressure in the dwelling process is approximately zero, molding failures may occur. Specific examples of the molding failures include a sink mark. It is enough that the forward flow end position of the molding material reaches a desired position.

The determination in step S104 is performed by the user in this embodiment, but may be performed by the controller 700. The controller 700 can determine whether or not the forward flow end position of the molding material upon completion of the stopping process reaches a desired position using a sensor provided in the mold part 800. As the sensor, for example, a pressure sensor or a temperature sensor is used.

When the forward flow end position of the molding material upon completion of the stopping process does not reach a desired position in the first test molding (NO in step S104), the process subsequent to step S102 is performed again. By repeatedly performing the first test molding while gradually advancing the V/P switchover position, the user can provide conditions upon completion of the filling process so that the forward flow end position of the molding material upon completion of the stopping process becomes a desired position. Thereby, conditions upon completion of the filling process can be provided so that the molding material flows into the mold part 800 by the action of the residual pressure in the stopping process.

Meanwhile, when the forward flow end position of the molding material upon completion of the stopping process reaches a desired position in the first test molding (YES in step S104), the user presses the complete button 1202 of the first input field 1200 (step S105). When the controller 700 determines that the complete button 1202 of the first input field 1200 is pressed, the controller 700 stores the conditions of the filling process and the conditions of the stopping process (step S204). The order of step S204 and step S205 that will be described below may be reversed.

The controller 700 performs switching of the display of the guidance screen 1000 as illustrated in FIG. 10 (step S205). A mark indicating that the first test molding is completed is displayed in the display section 1203 of the first input field 1200. In addition, a mark indicating that providing conditions using the second input field 1300 is in progress is displayed in the display section 1303 of the second input field 1300. Further, in the display section 1301 of the second input field 1300, the contents of the next operation to be executed by the user are displayed.

The user inputs conditions of the dwelling process in the second test molding (step S106). For example, the user inputs the set values T1 to T4 of the dwell time, the set values P1 to P4 of the pressure, the set value V0 of the travel speed of the screw 330, or any combination thereof.

Next, in order to execute the second test molding, the user presses an unillustrated molding start button (step S107). When the controller 700 determines that the molding start button is pressed, the controller 700 performs the second test molding and performs switching of the display of the guidance screen 1000 as illustrated in FIG. 11 (step S206). The guidance screen 1000 includes a second determination field 1600.

The second determination field 1600 is displayed as a pop-up display so as to overlap the second input field 1300 in this embodiment. However, the second determination field 1600 may be always displayed in a dedicated area. The second determination field 1600 is configured to receive an input indicating that a molded product having a desired quality is produced in the second test molding. For example, the second determination field 1600 includes option buttons 1601 and 1602. In place of the option buttons 1601 and 1602, a check box may be provided.

The user checks the molded product removed from the mold part 800 after the second test molding and determines whether or not a molded product having a desired quality is produced in the second test molding (step S108). The user inputs the determination result to the second determination field 1600. The determination in step S108 is performed by the user in this embodiment, but may be performed by the controller 700. The controller 700 can determine whether or not a molded product having a desired quality is produced in the second test molding using a sensor, such as a capturing sensor, a weight sensor, or the like.

When a molded product having a desired quality is not produced in the second test molding (NO in step S108), the process subsequent to step S106 is performed again. By repeatedly performing the second test molding while gradually changing the conditions of the dwelling process, the user can provide conditions of the dwelling process so as to produce a molded product having a desired quality. Because providing conditions upon completion of the filling process is completed before providing conditions of the dwelling process, the effect of the stopping process can be obtained.

Meanwhile, when a molded product having a desired quality is produced in the second test molding (YES in step S108), the user presses the complete button 1302 of the second input field 1300 (step S109). When the controller 700 determines that the complete button 1302 of the second input field 1300 is pressed, the controller 700 stores the conditions of the dwelling process (step S207).

The controller 700 performs full-automatic operation in accordance with the conditions of the injection process stored in step S204 and step S207.

Although the embodiments of the display device of the injection molding machine and the injection molding machine according to the present invention have been described above, the present invention is not limited to the above embodiments. Various changes, modifications, substitutions, additions, deletions, and combinations are possible within the scope of claims recited. These fall within the technical scope of the present invention.

What is claimed is:

1. A display device of an injection molding machine, the display device comprising:
a circuit configured to display a guidance screen that assists in providing conditions of an injection process, wherein
the injection process sequentially includes a filling process of controlling a travel speed of an injection member, a stopping process of stopping travel of the injection member, and a dwelling process of controlling a pressure applied from the injection member to a molding material,
the guidance screen includes a first input field configured to receive an input of conditions upon completion of the filling process in a first test molding, and
in the first test molding, the filling process is performed under the conditions input to the first input field and subsequently the stopping process is performed, and then the dwelling process is performed under conditions that enable confirming a position of the molding material upon completion of the stopping process, the position being a position of a forward end of the molding material in a direction in which the molding material flows.

2. A display device of an injection molding machine, the display device comprising:
a circuit configured to display a guidance screen that assists in providing conditions of an injection process, wherein
the injection process sequentially includes a filling process of controlling a travel speed of an injection member, a stopping process of stopping travel of the injection member, and a dwelling process of controlling a pressure applied from the injection member to a molding material,
the guidance screen includes a first input field configured to receive an input of conditions upon completion of the filling process in a first test molding, and
in the first test molding, the filling process is performed under the conditions input to the first input field and subsequently the stopping process is performed, and then the dwelling process is performed under conditions in which the pressure applied from the injection member to the molding material is approximately zero.

3. The display device of the injection molding machine according to claim 1, wherein
the guidance screen includes
a first determination field configured to receive an input indicating that the position of the molding material upon completion of the stopping process reaches a desired position in the first test molding.

4. The display device of the injection molding machine according to claim 1, wherein
the guidance screen includes
a second input field configured to receive an input of conditions of the dwelling process in a second test molding performed after the first test molding, and
in the second test molding, the filling process is performed under the conditions input to the first input field and subsequently the stopping process is performed, and then the dwelling process is performed under the conditions input to the second input field.

5. The display device of the injection molding machine according to claim 4, wherein
the guidance screen includes
a second determination field configured to receive an input indicating that a molded product having a desired quality is produced in the second test molding.

6. The display device of the injection molding machine according to claim 4, wherein
the guidance screen includes
a display field configured to collectively display the conditions input to the first input field and the conditions input to the second input field, apart from the first input field and the second input field.

7. An injection molding machine, comprising:
the display device according to claim 1; and
the injection member.

8. The display device of the injection molding machine according to claim 2, wherein
the guidance screen includes
a first determination field configured to receive an input indicating that a position of the molding material upon completion of the stopping process reaches a desired position in the first test molding, the position of the molding material being a position of a forward end of the molding material in a direction in which the molding material flows.

9. The display device of the injection molding machine according to claim 2, wherein
the guidance screen includes
a second input field configured to receive an input of conditions of the dwelling process in a second test molding performed after the first test molding, and
in the second test molding, the filling process is performed under the conditions input to the first input field and subsequently the stopping process is performed, and then the dwelling process is performed under the conditions input to the second input field.

10. An injection molding machine, comprising:
the display device according to claim 2; and
the injection member.
